(19) United States
(12) Patent Application Publication
(10) Pub. No.: US 2009/0271103 A1
(43) Pub. Date: Oct. 29, 2009

(54) NAVIGATION DEVICE, NAVIGATION METHOD, NAVIGATION PROGRAM, AND RECORDING MEDIUM HAVING NAVIGATION PROGRAM RECORDED THEREON

(75) Inventor: Yoshimichi Nishio, Kawagoe-shi (JP)

Correspondence Address: YOUNG & THOMPSON, 209 Madison Street, Suite 500, ALEXANDRIA, VA, 22314, US

(73) Assignee: PIONEER CORPORATION, Tokyo (JP)

(21) Appl. No.: 12/065,735

(22) PCT Filed: Sep. 7, 2006
(86) PCT No.: PCT/JP2006/317775

§ 371 Date: Mar. 17, 2008

(30) Foreign Application Priority Data
Sep. 29, 2005 (JP) 2005-283383

(51) Int. Cl. G01C 21/00

(52) U.S. Cl. 701/200

(57) ABSTRACT

In a navigation-related processing, when it is necessary to access a navigation data area 121 in a hard disk device, an access data amount determining portion 211 determines whether the navigation-related processing includes access by a predetermined amount or more of data. When the determination result is affirmative, an access restriction instructing portion 212 sends a hard disk access restricting instruction to a disk recording processing portion 221. In a state where the access of the disk recording processing portion 221 to an additional-function data area 122 of the hard disk is restricted, a navigation processing section 210 accesses the navigation data area 121. As a result, even when a navigation-related processing and a specific additional function-related process other than a navigation function are concurrently performed, it is possible to provide navigation information well.

### TECHNICAL FIELD

The present invention relates to a navigation system, a navigation method, a navigation program, and a recording medium.

### BACKGROUND ART

Conventionally, navigation systems mounted on vehicles, etc. so as to provide navigation information such as map information on traveling route were widely spread. The development in technology of such navigation systems is drastic. In recent years, navigation systems which can perform a basic function of providing the navigation information and an additional function different from the basic function came to the market.

As a navigation system for performing a basic function and an additional function, a navigation system which reproduces music in the additional function by sharing calculation resources for the navigation function as the basic function has been suggested (see Patent Literature 1, which is hereinafter referred to as “conventional example”). In the navigation system according to the conventional example, music data of a digital type recorded in a music CD (CD-DA: Compact Disk—Digital Audio) are converted into reproducing data having a file format which can be processed by a processor for performing a navigation-related processing which is the basic function and then are stored in a hard disk device. Under the control of the processor, music reproducing data are read out from the hard disk and music is reproduced using the read music reproducing data.

On the other hand, in the navigation system according to the conventional example, when a map display process which is one navigation-related processing is performed, necessary map data are read from the hard disk and a map is displayed using the map data. Then, by preparing exclusive hardware resources, the navigation-related processing and the music data-related process in which the hard disk is accessed can be concurrently performed without increasing a processing burden of the processor

[Patent Literature 1] Japanese Unexamined Patent Publication No. 2005-172563

### DISCLOSURE OF THE INVENTION

### Problems to be Solved by the Invention

In the conventional example, since operation guidance for reproducing music, such as start or stop of reproduction or selection of musical pieces, can be made by the use of a processor having high capability, it is excellent in improvement of a user's convenience In addition, most of the resources for performing the music reproducing process and the resources for performing the navigation-related processing can be shared.

However, when the navigation-related processing accompanied with access to the hard disk and the additional function process such as the music data-related process are performed concurrently, the access operations to the hard disk associated with the processes concur. Such concurrence occurs even when exclusive hardware resources are provided to reduce the load of the processor for access to the hard disk like the conventional example.

When such concurrence occurs, a method was generally employed in which the processes intend to access the hard disk as if the concurrence does not occur, wait until an empty time is generated for the access to the hard disk in another process when the another process in access exists, and then access the hard disk.

When the conventional method of processing the concurrence in access to the hard disk is employed, the time until all the plural processes accompanied with the access to the hard disk which are concurrently performed are ended is the shortest. However, from the viewpoint of the respective processes, the time until the end of any process is elongated in comparison with a case of no concurrence, thereby deteriorating the processing performance. The deterioration in processing performance is remarkable when processes having a large amount of data in the hard disk to be accessed are concurrently performed.

On the other hand, in the navigation system, it is necessary to avoid the deterioration in processing performance of the navigation-related processing as the basic function as much as possible. That is, a problem of the invention to be solved is to avoid the deterioration in processing performance of the navigation-related processing which gives an unpleasant feeling to a user when a navigation-related processing and an additional-function process, although the deterioration in processing performance of navigation-related processing which concur with each other could be tolerated to a certain extent.

The invention is contrived to solve the above-mentioned problem. An object of the invention is to provide a user with navigation information well even when a navigation-related processing and a specific additional-function process different from a navigation function are concurrently performed.

### Means for Solving the Problems

According to a first aspect of the invention, the present invention is a navigation system comprising: storage means having a navigation data area used for a navigation-related processing and an additional-function data area used for an additional-function processing other than a navigation function; and processing control means for restricting access to the additional-function data area accompanied by a specific additional-function process and performing a specific navigation-related processing, when it is necessary to perform the specific navigation-related processing accompanied with access to the navigation data area by an amount of data not less than a predetermined amount.

According to a second aspect of the invention, the present invention is a navigation method comprising: an access data amount determining step of determining whether a navigation-related processing is a specific navigation-related processing accompanied with access to a navigation data area by an amount of data not less than a predetermined amount, when it is necessary to perform the navigation-related processing which is performed while accessing the navigation data area of storage means; and a specific navigation-related processing performing step of restricting access to an additional-function data area accompanied by a specific additional-function process other than a navigation function, which is performed while accessing the additional-function data area of the storage means, and performing the specific navigation-related processing when the determination result of the access data amount determining step is affirmative.

According to a third aspect of the invention, the present invention is a navigation program allowing calculation means of a navigation system to execute the above-mentioned navigation method.

According to a fourth aspect of the invention, the present invention is a recording medium in which the above-mentioned navigation program is recorded to be read by the calculation means of the navigation system.

### BRIEF DESCRIPTION OF THE DRAWINGS

FIG. 1 is a block diagram schematically illustrating a configuration of a navigation system according to an embodiment of the invention;

FIG. 2 is a block diagram illustrating a configuration of a program executed by a control unit shown in FIG. 1;

FIG. 3 is a flowchart illustrating a hard-disk access restricting process performed in a specific navigation-related processing;

FIG. 4 is a sequence diagram (No. 1) illustrating a hard disk access operation at the time of concurrently performing a specific navigation-related processing and a disk recording processing;

FIG. 5 is a sequence diagram (No. 2) illustrating the hard disk access operation at the time of concurrently performing a specific navigation-related processing and a disk recording processing;

FIG. 6 is a sequence diagram (No. 3) illustrating the hard disk access operation at the time of concurrently performing a specific navigation-related processing and a disk recording processing; and

FIG. 7 is a sequence diagram (No. 4) illustrating the hard disk access operation at the time of concurrently performing a specific navigation-related processing and a disk recording processing.

### BEST MODE FOR CARRYING OUT THE INVENTION

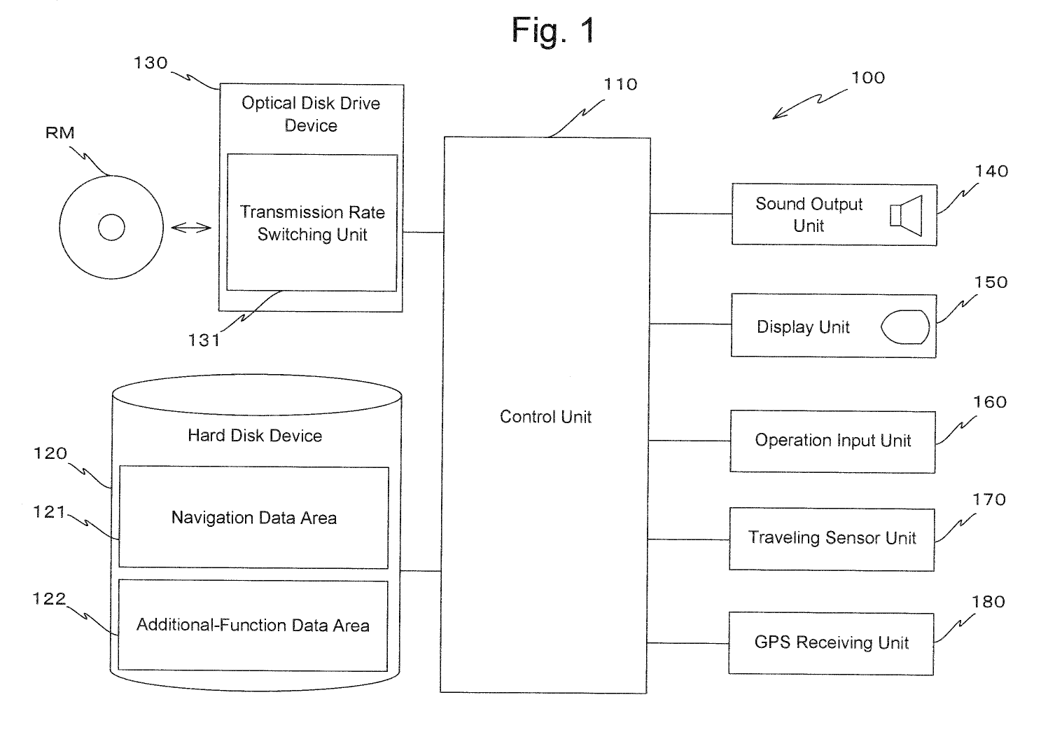

Hereinafter, an embodiment of the invention will be described with reference to FIGS. 1 to 7. In this embodiment, a navigation system for navigating the traveling of a vehicle as a moving object will be exemplified.

### [Configuration]

In FIG. 1, a schematic configuration of a navigation system 100 according to this embodiment is shown as a block diagram. As shown in FIG. 1, the navigation system 100 comprises a control unit 110 also serving as calculating means, a hard disk device 120 as memory means, and an optical disk drive 130 as contents data reading means.

The navigation system 100 comprises a sound output unit 140, a display unit 150, and an operation input unit 160. The navigation system 100 further comprises a traveling sensor unit 170 and a GPS (Global Positioning System) receiving unit 180.

Elements 120 to 180 other than the control unit 110 are connected to the control unit 110.

The control unit 110 serves to intensively control the entire navigation system 100 and to perform a navigation-related processing, a music data-related process, and the like. The control unit 110 includes a central processing unit (CPU), an exclusive memory (ROM: Read Only Memory), a random access memory (RAM), and the like and serves to execute various programs. Configurations of the programs executed by the control unit 110 will be described later.

A hard disk device 120 stores various data such as map data, music reproducing data, and programs executed by the control unit 110. The control unit 110 can access a memory area of the hard disk device 120 and can write data to the memory area or read data from the memory area.

The hard disk device 120 is provided with a navigation data area 121 and an additional-function data area 122. The navigation data area 121 stores navigation data such as map data used for navigation-related processing for performing a navigation function as a basic function of the navigation system 100. The additional-function data area 122 stores additional-function data used for processing an additional function other than the navigation function.

An example of the additional function includes a music reproducing function, a video reproducing function, and a TV receiving function. The navigation system 100 according to this embodiment having the music reproducing function built therein; (i) a disk recording operation of reading music data of a digital type from a music CD as a recording medium inserted into an optical disk drive device 130, converting the read music data of a digital type into music reproducing data having a file format suitable for the control unit 110, and then storing the music reproducing data in the disk device 120 and (ii) a music output operation of reading the music reproducing data from the hard disk device 120, reproducing the read music reproducing data, and outputting the reproduced music from a sound output unit 140 can be performed by the music reproducing function built in the navigation system 100.

The optical disk drive device 130 reads digital data from a recording medium RM such as a CD or DVD on which data are recorded in a digital type and outputs the read digital data to a control unit 110. For example, the optical disk drive device 130 reads music data of a digital type from a music CD and outputs the read music data of a digital type to the control unit 110, or reads updating map data or updated program data from a DVD and outputs the read data to the control unit 110.

The optical disk drive device 130 is mounted with a transmission rate switching unit 131 as transmission rate switching means and can change a data transmission rate to the control unit 110 in accordance with a transmission rate selecting instruction from the control unit 110. The optical disk drive device 130 according to this embodiment can output data in the ATAPI (AT Attachment Packet Interface) format and can change the transmission rate in response to the transmission rate selecting instruction from the control unit 110. The optical disk drive device can output data in a serial format having a data transmission rate lower than that of the ATAPI format as well as in the ATAPI format and the transmission rate switching unit 131 can switch the data output format in response to an output format selecting instruction as the transmission rate selecting instruction from the control unit 110.

The sound output unit 140 includes (i) a DA (Digital-to-Analog) converter for converting digital voice data received from the control unit 110 into analog signals, (ii) an amplifier for amplifying the analog signals output from the DA converter, and (iii) a speaker for converting the amplified analog signals into voice. The sound output unit 140 outputs guiding voice such as a traveling direction of a vehicle, a traveling condition, and a traffic condition and music under the control of the control unit 110.

The display unit 150 includes (i) a display device such as a liquid crystal panel, an organic EL (Electro Luminescence) panel, and a PDP (Plasma Display Panel), (ii) a display controller such as a graphic renderer for controlling the entire display unit 150 on the basis of display control data transmitted from the control unit 110, and (iii) a display image memory for storing display image data. The display unit 150 displays map information, path information, and operation guidance information under the control of the control unit 110.

The operation input unit 160 includes a key unit disposed in a main body of the navigation system 100 or a remote input device having the key unit. Here, a touch panel disposed in the display device of the display unit 150 can be used as the key unit disposed in the main body. A configuration for inputting voice may be employed instead of the configuration including the key unit.

By allowing a user to operate the operation input unit 160, the operation details of the navigation system 100 are set. For example, the user performs the setting of a destination, the setting of search for information, the setting of traveling condition display of a vehicle, and the like by the use of the operation input unit 160. The input details are sent to the control unit 110 from the operation input unit 160.

A traveling sensor unit 170 includes (i) a speed sensor for detecting a traveling speed of a vehicle, (ii) a azimuth angle sensor for detecting a azimuth angle which means the traveling direction of the vehicle, and (iii) an acceleration sensor for detecting an acceleration acting on the vehicle. Here, for example, the speed sensor detects a pulse signal or a voltage value output with the rotation of a vehicle shaft or a vehicle wheel. The azimuth sensor is, for example, constituted as a gyro sensor, and it detects azimuth angle. The acceleration sensor detects, for example, a gravitational acceleration. The detection result is sent to the control unit 110 from the traveling sensor unit 170.

A GPS receiving unit 180 calculates a pseudo coordinate value of the present position of the vehicle on the basis of a radio wave receiving result from plural GPS satellites and reports the calculated value to the control unit 110. The GPS receiving unit 180 counts the present time on the basis of the transmission time from the GPS satellites and sends the counted time to the control unit 110.

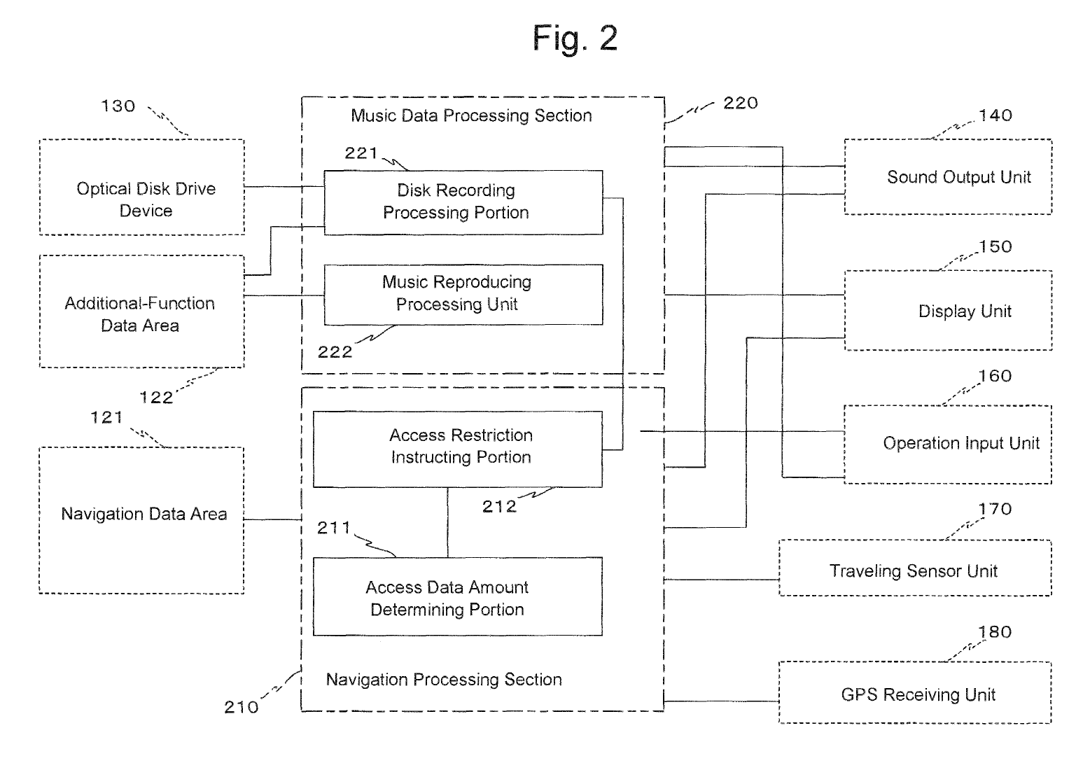

Next, a configuration a program executed by the control unit 110 will be described with reference to FIG. 2. As shown in FIG. 2, the program executed by the control unit 110 includes a navigation processing section 210 and a music data processing section 220. Here, the navigation processing section 210 also serves as processing control means for restricting the access to the hard disk device 120 as described later.

The navigation processing section 210 includes (i) an access data amount determining portion 211 for determining whether the amount of accessed data is not less than a predetermined amount of data (hereinafter, referred to as a “predetermined amount of data”) when it is necessary to access the navigation data area 121 of the hard disk device 120 in a navigation-related processing performed in the navigation processing section 210 and (ii) an access restriction instructing portion 212 for instructing a disk recording processing portion 221 described later of the music data processing section to restrict the access to the additional-function data area 122 of the hard disk device 120 when the determination result of the access data amount determining portion 211 is affirmative. The predetermined amount of data is determined at the time of design in consideration of a degree of deterioration in performance of the navigation-related processing expected to occur when no restriction is applied to the access of the disk recording processing portion 221 to the hard disk device 120.

The navigation-related processing executed by the navigation processing section 210 is classified into two kinds of processing: a highly-urgent processing and a low-urgent processing. When the determination result of the access data amount determining portion 211 is affirmative, the access restriction instructing portion 212 sends a disk record stopping instruction or a disk recording speed decreasing instruction to the disk recording processing portion 221 depending on whether the navigation-related processing requiring the access to the navigation data area 121 is the highly-urgent process or the low-urgent processing. It is determined at the time of design depending on the assumed degree of urgency whether the respective navigation-related processing is a highly-urgent processing or a low-urgent processing.

The music data processing section 220 includes (i) a disk recording processing portion 221 for performing a disk recording processing which is a processing to convert music data of a digital type read by a music CD in the optical disk drive device 130 into music reproducing data of a file format which can be treated by a music reproducing portion 222 described later and storing the music reproducing data in the additional-function data area 122 of the hard disk device 120 and (ii) a music reproducing portion 222 for acquiring the music reproducing data read from the additional-function data area 122 of the hard disk device 120 and reproducing music by the use of the sound output unit 140.

Here, when the navigation processing section 210 instructs to restrict the access to the hard disk device 120, the disk recording processing portion 221 restricts the access to the hard disk device 120 depending on the details of the access restriction. Specifically, the disk recording processing portion 221 temporarily stops the disk recording processing, or controls the transmission rate switching unit 131 to reduce the transmission rate and reduces a data output speed from the optical disk drive device 130, thereby restricting the access to the hard disk device 120. Here, at the time of reducing the transmission rate, the disk recording processing portion 221 instructs the transmission rate switching unit 131 to designate the decrease in transmission rate of the data having the ATAPI format or to designate the output of data having the serial format of which the output rate is lower than that of data having the ATAPI format.

In this embodiment, when the disk recording processing performed by the disk recording processing portion 221 among the music data processes of the additional function is a specific additional function of which the access to the hard disk device 120 is restricted, when it is concurrently performed with the navigation-related processing of the navigation processing section 210.

### [Operations]

Next, an operation of the navigation-related processing and an operation of the music data-related process in the navigation system 100 having the above-mentioned configuration will be described.

### <Navigation-Related Process>

The navigation-related processing is performed by allowing the navigation processing section 210 to provide navigation information to a user using the above-mentioned elements 140 to 180 while accessing the navigation data area 121. That is, in accordance with the instruction input result from the operation input unit 160 associated with the navigation-related processing, the detection result of the traveling sensor unit 170, and the measurement result of the GPS receiving unit 180, the navigation processing section 210 properly reads navigation data stored in the navigation data area 121. Then, the navigation processing section 210 performs (a) a map displaying operation of displaying a map of a region designated by a user on the display unit 150, (b) a map matching operation of calculating a position or a direction of a vehicle on the map and displaying the calculation result on the display unit 150 for the user, (c) a recommended path calculating operation of calculating a recommended path to a position designated by the user, and (d) a route guiding operation of displaying a guidance on the display unit 150 or outputting a voice guidance from the sound output unit 140 so as to accurately inform the user of the traveling direction at the time of driving to a destination along a set path.

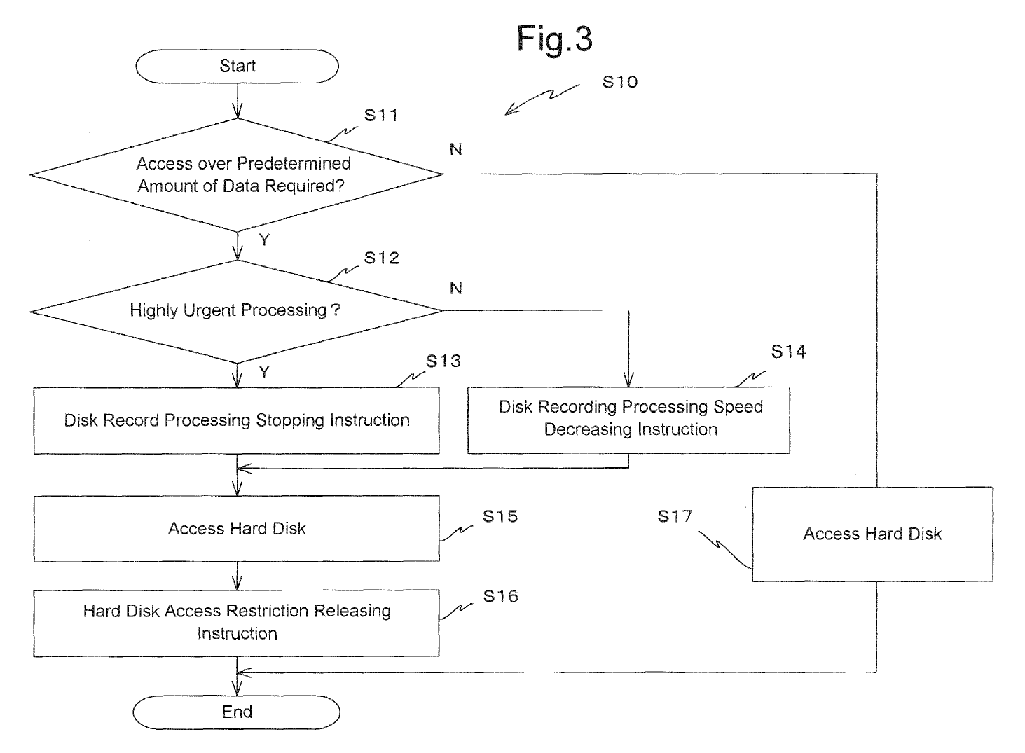

At the time of performing the navigation-related processing, the navigation processing section 210 performs a hard disk concurrence control setting and hard disk accessing process S10 shown in FIG. 3, when it is necessary to access the navigation data area 121 of the hard disk device 120. That is, in the navigation-related processing, when it is necessary to access the navigation data area 121, first, the access data amount determining portion 211 determines whether the amount of accessed data is not less than a predetermined amount in step S11.

When the amount of accessed data is less than the predetermined amount of data and thus the determination result of step S11 is negative, the access data amount portion 211 does not send information to the access restriction instructing portion 212. As a result, the process of step S17 is performed without allowing the navigation processing section 210 to actively set the hard disk concurrence control. In step S17, the necessary navigation data area 121 is accessed. When the access to the navigation data area 121 is ended, the process of step S10 is ended.

On the other hand, like reading the map data, when the amount of accessed data is not less than the predetermined data, the access restriction instructing portion 212 determines in step S12 whether the processing requiring the access to the navigation data area 121 is a highly-urgent processing. When the determination result is affirmative, the processing of step S13 is performed. In step S13, the access restriction instructing portion 212 gives a disk record stopping instruction to the disk recording processing portion 221 of the music data processing section 220.

On the other hand, when the determination result of step S12 is negative, the process of step S14 is performed. In step S14, the access restriction instructing portion 212 gives a disk recording processing speed decreasing instruction to the disk recording processing portion 221.

In this way, after sending an instruction to restrict the access to the hard disk device 120 which is the disk record stopping instruction or the disk recording processing speed decreasing instruction, the navigation processing section 210 accesses the navigation data area 121 in step S15 as needed. When the access is ended, the access restriction instructing portion 212 of the navigation processing section 210 gives an instruction to release the restriction of the access to the hard disk device 120 to the disk recording processing portion 221. Then, the process of step S10 is ended.

The navigation processing section 210 performs various navigation-related processing while performing the hard disk concurrence control setting and hard disk accessing process S10 described above.

<Music Data-Related process>

Music data are processed by the music data processing section 220 using the above-mentioned elements 140 to 150 while accessing the optical disk drive device 130 or the additional-function data area 122. The music data process includes a disk recording processing performed by the disk recording processing portion 221 and a music reproducing processing performed by the music reproducing portion 222.

### (1) Disk Recording Process

When a music CD is inserted into the optical disk drive device 130 and then a disk recording instruction is input from the operation input unit 160 in accordance with the operation guidance displayed on the display unit 150, the disk recording processing portion 221 performs the disk recording processing. When the disk access restricting instruction is not sent from the access restriction instructing portion 212 of the navigation processing section 210 at the time performing the disk recording processing, the disk recording processing portion 221 allows the transmission speed switching unit 131 of the optical disk drive device 130 to select the high-speed data output of the ATAPI format. As a result, the disk recording processing portion 221 acquires the music data of a digital type output in the format of ATAPI at a high speed from the optical disk drive device 130.

Subsequently, the disk recording processing portion 221 converts the acquired music data into the music reproducing data having a file format which can be treated by the music reproducing portion 222 and stores the music reproducing data in the additional-function data area 122 of the hard disk device 120. Accordingly, when the disk access restricting instruction is not sent from the access restriction instructing portion 212, the disk recording processing portion 221 performs a disk recording processing as at a high speed as possible (hereinafter, also referred to as a “high-speed disk recording processing”).

On the other hand, when a disk recording speed decreasing instruction is given from the access restriction instructing portion 212, the disk recording processing portion 221 allows the transmission rate switching unit 131 of the optical disk drive device 130 to select the decrease in transmission rate of data having the format of ATAPI. The disk recording processing portion 221 may designate the outputting of data having a serial format of which the data output speed is lower than that of the data having the ATAPI format. In this case, the disk recording processing portion 221 acquires music data of a digital type output in the serial format from the optical disk drive device 130.

Subsequently, the disk recording processing portion 221 converts the acquired music data into music reproducing data having a file format which can be treated by the music reproducing portion 222 and stores the music reproducing data in the additional-function data area 122 of the hard disk device 120. Accordingly, when the disk recording speed decreasing instruction is given, the frequency of access to the additional-function data area 122 is reduced in comparison with the case where the disk access restricting instruction is not given, thereby performing a low-speed disk recording processing of which the disk recording speed is decreased.

When the disk record stopping instruction is given from the access restriction instructing portion 212 in the course of performing the disk recording processing, the disk recording processing portion 221 gives a pause instruction to the optical disk drive device 130 to stop the acquiring of music data and temporarily stops the disk recording processing. on the other hand, when the disk record stopping instruction is given and then a disk recording instruction is given from the operation input unit 160, the disk recording processing portion 221 waists for starting the disk recording processing until the hard disk access restriction releasing instruction is given from the access restriction instruction portion 212.

As described above, when the disk access restricting instruction such as the disk recording speed decreasing instruction or the disk record stopping instruction is given and then the hard disk access restriction releasing instruction is given from the access restriction instructing portion 212, the disk recording processing portion 221 performs a high-speed disk recording processing.

### (2) Music Reproducing Process

When a music reproducing instruction is input from the operation input unit 160 in accordance with the operation guidance displayed on the display unit 150, the music reproducing portion 222 performs the music reproducing process. In the music reproducing process, the music reproducing portion 222 first reads the music reproducing data corresponding to a musical piece designated by the music reproducing instruction from the additional-function data area 122 of the hard disk device 120. Subsequently, the music reproducing portion 222 sequentially sends the read music reproducing data to the sound output unit 140. The sound output unit 140 having received the music reproducing data sent from the music reproducing portion 222 reproduces the musical piece and provides the reproduced musical piece to the user.

### <Concurrent Operation of Specific Navigation-Related Process and Disk Recording Process>

Next, it will be mainly described to adjust the concurrence of access to the hard disk device 120 at the time of concurrently performing a specific navigation-related processing accompanied with access by an amount of data greater than a predetermined amount of data and a disc recording processing as a specific additional function.

(1) When it is necessary to access the hard disc device 120 in a specific navigation-related processing in the course of performing the disk recording processing

It is assumed that the disk access restricting instruction is not given from the access restriction instructing portion 212 of the navigation processing section 210 at the time point when the disk recording instruction is given from the operation input unit 160.

(1-1) When the specific navigation-related processing is a highly-urgent processing

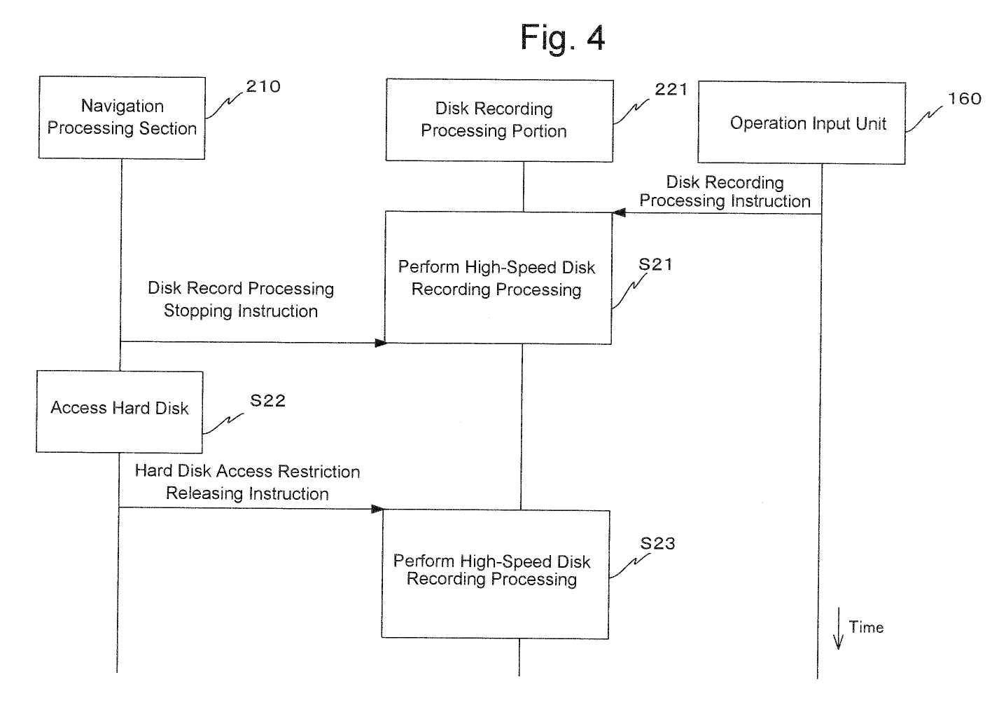

As shown in FIG. 4, when the disk recording instruction is given from the operation input unit 160, the disk recording processing portion 221 starts the high-speed disk recording processing of step S21. During the high-speed disk recording processing of step S21, when it is necessary to access the navigation data area 121 of the hard disk device 120 in the navigation-related processing as a highly-urgent processing, as described above, the access restriction instructing portion 212 of the navigation processing section 210 sends the disk record stopping instruction to the disk recording processing portion 221 (see step S13 in FIG. 3).

The disk recording processing portion 221 having received the disk record stopping instruction temporarily stops the high-speed disk recording processing of step S21 as rapidly as possible. On the other hand, the navigation processing section 210 accesses the navigation data area 121 in step S22 after sending the disk record stopping instruction. As a result, the navigation processing section 210 can access the navigation data area 121 without any concurrence with the disk recording processing portion 221. Accordingly, the navigation processing section 210 can end the access to the navigation data area 121 for a short time.

When the access of the navigation processing section 210 to the navigation data area 121 in step S22 is ended, the access restriction instructing portion 212 gives a hard disk access restriction releasing instruction to the disk recording processing portion 221 (see step S16 in FIG. 3). The disk recording processing portion 221 having received the hard disk access restriction releasing instruction resumes the high-speed disk recording processing of step S23. Then, until the disk recording processing is ended or the hard disk access restricting instruction is given from the access restriction instructing portion 212, the disk recording processing portion 221 continues to perform the high-speed disk recording processing.

(1-2) When the specific navigation-related processing is a low-urgent processing

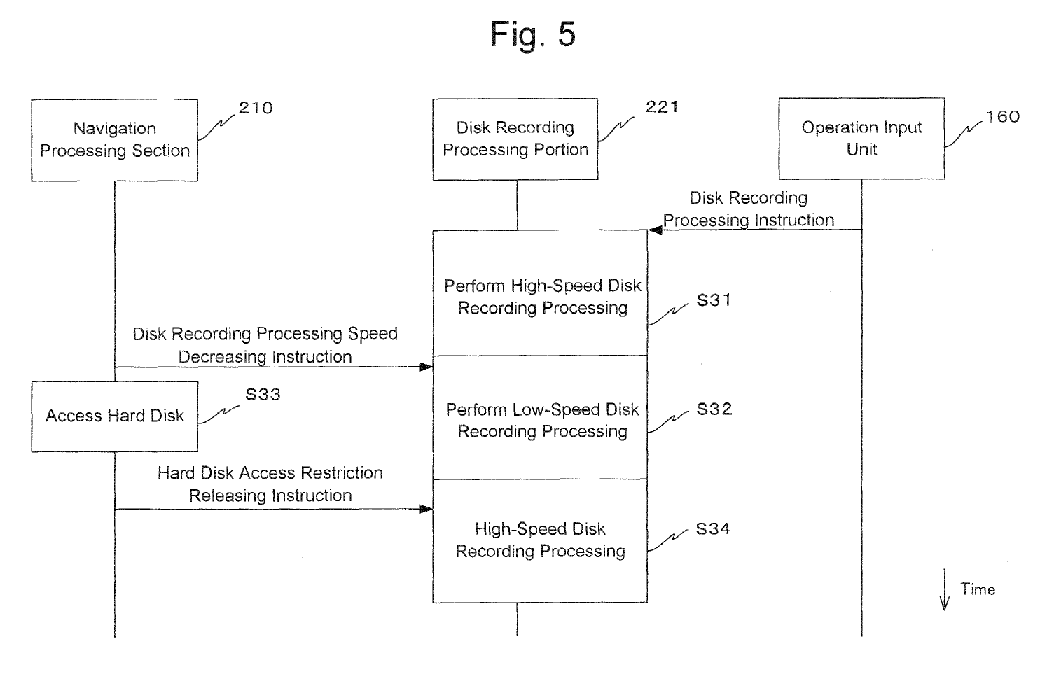

As shown in FIG. 5, when a disk recording instruction is given from the operation input unit 160, the disk recording processing portion 221 starts the high-speed disk recording processing of step S31, similarly to the case where the specific navigation-related processing is a low-urgent processing. In the course of performing the high-speed disk recording processing of step S31, when the access to the navigation data area 121 of the hard disk device 120 is required for the navigation-related processing as the low-urgent processing, as described above, the access restriction instructing portion 212 of the navigation processing section 210 gives a disk recording speed decreasing instruction to the disk recording processing portion 221 (see step S14 in FIG. 3).

The disk recording processing portion 221 having received the disk recording speed decreasing instruction switches the high-speed disk recording processing of step S31 into the low-speed disk recording processing of step S32 as rapidly as possible. On the other hand, the navigation processing section 210 accesses the navigation data area 121 in step S33 after giving the disk record stopping instruction. As a result, the access of the disk recording processing portion 221 performing the low-speed disk recording processing to the hard disk device 120 and the access of the navigation processing section 210 to the hard disk device 120 are concurrently performed. The access of the navigation processing section 210 to the hard disk device 120 in the concurrent operations is more restricted in comparison with the concurrence of access does not occur, but is alleviated in concurrence in comparison with the case where it concurs with the access of the disk recording processing portion 221 performing the high-speed disk recording processing to the hard disk device 120. Accordingly, the navigation processing section 210 can end the access to the navigation data area 121 for a shorter time than that when it concurs with the access of the high-speed disk recording processing, not as much as when it does not compete with the access of the disk recording processing.

When the access of the navigation processing section 210 to the navigation data area 121 in step S33 is ended, the access restriction instructing portion 212 gives the hard disk access restriction releasing instruction to the disk recording processing portion 221 (see step S16 in FIG. 3). The disk recording processing portion 221 having received the hard disk access restriction releasing instruction switches the low-speed disk recording processing of step S32 to the high-speed disk recording processing of step S34. Then, until the disk recording processing is ended or the hard disk access restricting instruction is given again from the access restriction instructing portion 212, the disk recording processing portion 221 continues to perform the high-speed disk recording processing.

(2) When the disk record starting instruction is given during the access of the specific navigation-related processing to the hard disk device

(2-1) When the specific navigation-related processing is a highly-urgent processing

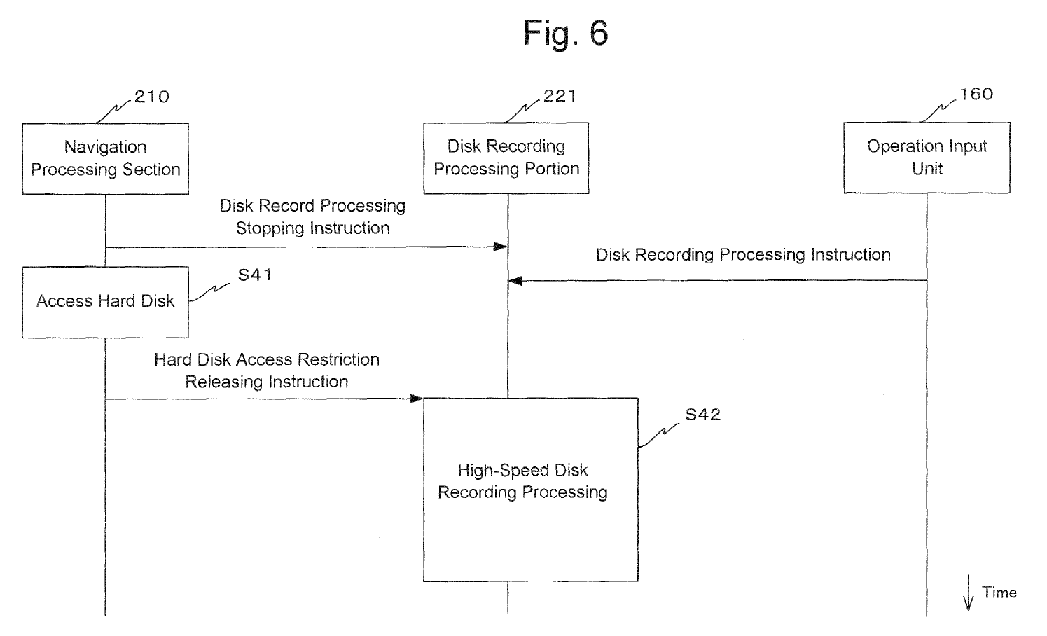

As shown in FIG. 6, when the access to the navigation data area 121 of the hard disk device 120 is required for the navigation-related processing as a highly-urgent processing, the access restriction instructing portion 212 of the navigation processing section 210 gives a disk record stopping instruction to the disk recording processing portion 221 as described above (see step S13 in FIG. 3). Subsequently, the navigation processing section 210 accesses the navigation data area 121 in step S41.

During the access of the navigation processing section 210 to the navigation data area 121 in step S41, when the disk recording instruction is given from the operation input unit 160, the disk recording processing portion 221 detects that the disk record stopping instruction is given and waits for the start of the disk recording processing until the hard disk access restriction releasing instruction is given from the access restriction instructing portion 212. As a result, the navigation processing section 210 can access the navigation data area 121 in a state where there is no concurrence with the disk recording processing portion 221. Accordingly, the navigation processing section 210 can end the access to the navigation data area 121 for a short time.

When the access of the navigation processing section 210 to the navigation data area 121 in step S41 is ended, the access restriction instructing portion 212 gives the hard disk access restriction releasing instruction to the disk recording processing portion 221 (see step S16 in FIG. 3). The disk recording processing portion 221 having received the hard disk access restriction releasing instruction starts the high-speed disk recording processing of step S42. Then, until the disk recording processing is ended or the hard disk access restricting instruction is given again from the access restriction instructing portion 212, the disk recording processing portion 221 continues to perform the high-speed disk recording processing.

(2-2) When the specific navigation-related processing is a low-urgent processing

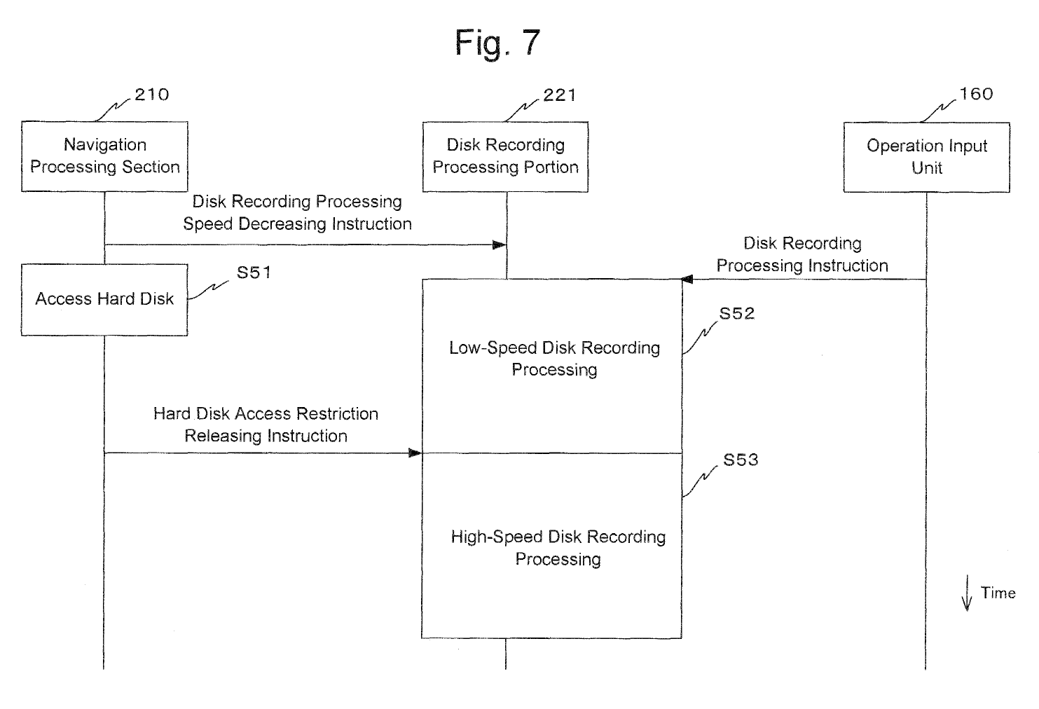

As shown in FIG. 7, when the access to the navigation data area 121 of the hard disk device 120 is required for the navigation-related processing as a low-urgent processing, the access restriction instructing portion 212 of the navigation processing section 210 gives a disk recording speed decreasing instruction to the disk recording processing portion 221 (see step S13 in FIG. 3). Subsequently, the navigation processing section 210 accesses the navigation data area 121 in step S51.

During the access of the navigation processing section 210 to the navigation data area 121 in step S51, when the disk recording instruction is given from the operation input unit 160, the disk recording processing portion 221 detects that the disk recording speed decreasing instruction is given and starts the low-speed disk recording processing of step S52. As a result, the access of the disk recording processing portion 221 performing the low-speed disk recording processing to the hard disk device 120 and the access of the navigation processing section 210 to the hard disk device 120 are concurrently performed. Accordingly, the navigation processing section 210 can end the access to the navigation data area 121 for a shorter time than that when it concurs with the access of the high-speed disk recording processing, not as much as when it does not compete with the access of the disk recording processing.

When the access of the navigation processing section 210 to the navigation data area 121 in step S51 is ended, the access restriction instructing portion 212 gives the hard disk access restriction releasing instruction to the disk recording processing portion 221 (see step S16 in FIG. 3). The disk recording processing portion 221 having received the hard disk access restriction releasing instruction switches the low-speed disk recording processing of step S52 to the high-speed disk recording processing of step S53. Then, until the disk recording processing is ended or the hard disk access restricting instruction is given again from the access restriction instructing portion 212, the disk recording processing portion 221 continues to perform the high-speed disk recording processing.

### [Working-Effect]

As described above, in this embodiment, when the access to the navigation data area 121 of the hard disk device 120 as the storage means is required for the navigation-related processing as the basic function of the navigation system 100, the access data amount determining portion 211 as a part of the processing control means determines whether the navigation-related processing is a specific navigation-related processing performing the access by a predetermined amount or more of data. When the determination result is affirmative, the access restriction instructing portion 212 as a part of the processing control means gives the hard disk access restricting instruction to the disk recording processing portion 221 performing the disk recording processing as a specific additional function. The disk recording processing portion 221 having received the hard disk access restricting instruction restricts the access to the additional-function data area 122 of the hard disk 120 accompanied with the disk recording processing. In this way, in the state where the access to the additional-function data area 122 of the hard disk device 120 accompanied with the disk recording processing is restricted, the navigation processing section 210 performing the navigation-related processing accesses the navigation data area 121.

Accordingly, when the specific navigation-related processing and the disk recording processing are concurrently performed, the access of the specific navigation-related processing to the hard disk device 120 is first performed. Therefore, it is possible to complete the specific navigation-related processing for a time not giving an unpleasant feeling to a user, compared with the case where the concurrence does not occur. As a result, according to this embodiment, even when the navigation-related processing concurs with the specific additional function other than the navigation function, it is possible to satisfactorily provide a user with navigation information.

In this embodiment, the navigation-related processing is classified into a highly-urgent processing and a low-urgent processing. When the specific navigation-related processing as a highly-urgent processing requires the access to the navigation data area 121 of the hard disk device 120, the access restriction instructing portion 212 gives the disk record stopping instruction to the disk recording processing portion 221. In this case, the navigation processing section 210 can access the hard disk device 120 in the state where there is no competition with the disk recording processing. When the specific navigation-related processing as a low-urgent processing requires the access to the navigation data area 121 of the hard disk device 120, the access restriction instructing portion 212 gives the disk recording speed decreasing instruction to the disk recording processing portion 221. In this case, the navigation processing section 210 can access the hard disk device 120 for a shorter time than that when there is some competition with the usual disk recording processing, but not as much as when there is no concurrence with the disk recording processing. Accordingly, it is possible to control the competition of detailed accesses to the hard disk device 120 depending on the degree of urgency of the specific navigation-related processing.

### [Modification of Embodiment]

The invention is not limited to the above-mentioned embodiment, but may be modified in various forms.

For example, although it has been described in the above-mentioned embodiment that two kinds of access restriction of the disk record stopping and the disk recording speed decreasing could be used for the disk recording processing as the specific additional function of which the access to the hard disk device 120 is restricted, the access restriction may be made by only one of the disk record stopping and the disk recording speed decreasing. In this case, when it is determined in step S11 of FIG. 3 that the amount of accessed data is greater than the predetermined amount of data, one of the disk record stopping instruction of step S13 and the disk recording speed decreasing instruction of step S14 is given without determining in step S12 whether it is a highly-urgent processing. In addition, plural decreasing steps of the disk recording speed decreasing may be prepared.

Although it has been described in the above-mentioned embodiment that the functions of the navigation processing section 210 and the music data processing section 220 are embodied by executing the corresponding program, a part or all of the navigation processing section 210 and the music data processing section 220 may be embodied by hardware having firmware.

Although it has been described in the above-mentioned embodiment that the music data process is provided as an additional function and the disk recording processing of the music data process is used as the specific additional function of which the access to the hard disk device 120 is restricted, another additional function such as a video data process other than the navigation-related processing may be provided and any function in the provided additional function may be used as the specific additional function.

In the above-mentioned embodiment, it has been described that the storage means to which the access of the specific additional function is restricted is the hard disk device 120. However, when another storage means such as an optical magnetic disk is provided, the storage means may be used as an object to which the access of the specific additional function is restricted.

Although it has been described in the above-mentioned embodiment that the invention is applied to the navigation system mounted on a vehicle, the invention may be applied to a navigation system mounted on airplanes and ships. In addition, the invention may be applied to navigation systems mounted on a PDA (Personal Digital Assistant) as a portable device, a mobile phone, a PHS (Personal Handyphone System) terminal, a portable personal computer, and the like.

1. A navigation system comprising:
storage means having a navigation data area used for a navigation-related processing and an additional-function data area used for an additional-function processing other than a navigation function; and
processing control means for restricting access to the additional-function data area accompanied by a specific additional-function process and performing a specific navigation-related processing, when it is necessary to perform the specific navigation-related processing accompanied with access to the navigation data area by an amount of data not less than a predetermined amount.

2. The navigation system according to claim 1, wherein the restriction is one of a decrease in access frequency to the additional-function data area and a stop of access to the additional-function data area.

3. The navigation system according to claim 1, further comprising:
contents data reading means for reading digital contents data from a recording medium having the digital contents data associated with the specific additional function recorded thereon and outputting the read digital contents data; and
data converting means for converting the digital contents data output from the contents data reading means into reproducing data and storing the reproducing data in the additional-function data area.

4. The navigation system according to claim 3, wherein the contents data reading means comprises transmission rate switching means for switching a transmission rate at the time of transmitting the read data to the data converting means in response to a transmission rate selecting instruction for restricting the access to the additional-function data area.

5. The navigation system according to claim 4, wherein the contents data reading means further comprises a plurality of output paths having different communication speeds, and wherein the transmission rate switching means switches the transmission rate by switching the output paths for outputting the read data.

6. The navigation system according to claim 3, wherein the digital contents are music contents.

7. A navigation method comprising:
an access data amount determining step of determining whether a navigation-related processing is a specific navigation-related processing accompanied with access to a navigation data area by an amount of data not less than a predetermined amount, when it is necessary to perform the navigation-related processing which is performed while accessing the navigation data area of storage means; and
a specific navigation-related processing performing step of restricting access to an additional-function data area accompanied by a specific additional-function process other than a navigation function, which is performed while accessing the additional-function data area of the storage means, and performing the specific navigation-related processing when the determination result of the access data amount determining step is affirmative.

8. A navigation program allowing calculation means of a navigation system to execute the navigation method according to claim 7.

9. A recording medium in which the navigation program according to claim 8 is recorded to be read by the calculation means of the navigation system.
